(19) United States
(12) Patent Application Publication
(10) Pub. No.: US 2009/0167048 A1
(43) Pub. Date: Jul. 2, 2009

(54) Adjustable length vehicle trunk lock

(76) Inventors: Alex Luca, Valley Stream, NY (US); Daniel Luca, Valley Stream, NY (US)

Correspondence Address: ALFRED M. WALKER, 225 OLD COUNTRY ROAD, MELVILLE, NY, 11747-2712, US

(21) Appl. No.: 12/317,700

(22) Filed: Dec. 26, 2008

Related U.S. Application Data
(60) Provisional application No. 61/009,591, filed on Dec. 28, 2007.

(51) Int. Cl. E05C 17/36; B62D 25/12

(52) U.S. Cl. 296/76; 292/262; 296/1.07

(57) ABSTRACT

An adjustable length vehicle trunk locking assembly prevents violent excursions of a tied-down trunk hood during travel. The assembly includes a non-stretch rope, with a spring snap fitted at one end of the non stretch rope, which is fed through a ball line tightener having a second spring snap attached thereto. The spring snap at the end of the locking assembly engages around a structural member or hook attached to the inside of the trunk or hatch lid while the lid is open. The non-stretch rope is then fed through the ball line tightener to facilitate snapping the second spring snap to the trunk or hatch lock loop or other point at the bottom frame or beyond. Then the rope is tightened by pulling the lid in contact with the protruding object.

### RELATED APPLICATIONS

This application is based upon provisional application Ser. No. 61/009,591 filed Dec. 28, 2007 and claims priority under 35 U.S.C. § 119(e) therefrom, and is incorporated by reference herein.

### FIELD OF THE INVENTION

The present invention relates to an adjustable length vehicle trunk lock which prevents violent excursions of a tied-down trunk hood lid during travel.

### BACKGROUND OF THE INVENTION

Automobiles or SUV's are often used to carry objects which protrude from a trunk or rear hatch. Typically, elastic bungee cords are used to keep the trunk lid or hatch lid closed onto the protruding object. Sometimes nylon ropes are used, but these are less convenient. Even if the protruding object is protected by a bolster such as a rolled blanket or pillow placed between the lid edge and the object, often there is damage to the object, lid, or both at arrival. The problem arises due to the dynamics of a rolling vehicle, the mass of the trunk or hatch lid, and the elastic medium used to tie the lid down. When a bump, pothole, or uneven road surface is encountered violent excursions of the lid are often induced because the resonant frequency of the lid and elastic cord system is induced. This results in a constant rising and falling of the trunk lid, and subsequent violent contact of the trunk lid against the protruding cargo object protruding out of the trunk while being carried by the moving vehicle.

### OBJECTS OF THE INVENTION

It is an object of the present invention to provide an adjustable length vehicle trunk lock.

It is also an object of the present invention to prevent violent excursions of a tied-down trunk hood during travel.

Other objects which become apparent from the following description of the present invention.

### SUMMARY OF THE INVENTION

In keeping with these objects and others which may become apparent, the present invention provides a convenient length-adjustable tie-down assembly for holding the hinged trunk lid in a secure position when a protrusion carried in the trunk prevents the lid from closing upon the trunk. The assembly includes a non-stretch rope (such as polypropylene), a spring snap fitted at one end, with a distal end of the non stretch rope being fed through a ball line tightener, and a second spring snap attached to the ball line tightener. In use, the spring snap at the end of the assembly is preferably snapped onto or looped around a structural member or hook attached to the inside of the trunk or hatch lid while the lid is open. Rope is then fed through the ball line tightener to facilitate snapping the second spring snap to the trunk or hatch lock loop or other point at the bottom frame or beyond. Then the rope is tightened pulling the lid in contact with the protruding object. More damage-prone objects such as a bicycle should be protected by a soft bolster. Due to the non-stretch nature of the rope used and its adjustability, there should be no tendency for violent excursions of the lid during the road trip to a destination.

If the trunk or hatch lid interior is upholstered or otherwise devoid of attachment points, an auxiliary rope loop around the lid near its free end (away from the hinge) can be used to provide the attachment point for the spring snap. Non-stretch rope should be used.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a perspective view of the adjustable length tie-down locking assembly of this invention.

FIG. 2 is a perspective view of a vehicle trunk using the tie-down assembly of FIG. 1 to lock down a trunk on a protruding plank (open position is shown).

FIG. 3 is a perspective detail of a trunk lid using an auxiliary rope loop to provide an attachment point.

### DETAILED DESCRIPTION OF THE INVENTION

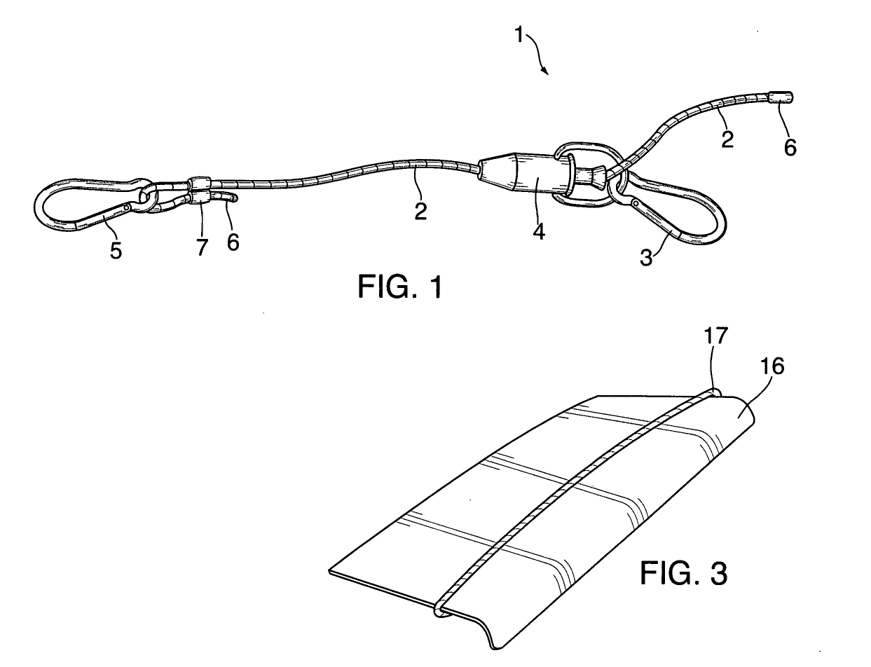

FIG. 1 shows tie-down assembly 1 with spring snap 5 fitted at one end of a non-stretch rope 2 while the distal end is threaded through a ball line tightener 4. Spring snap 3 is engaged with the ball line tightener 4. Respective ends of non-stretch rope 2 are sealed against fraying by a sealer such as shrink tubing 6. Preferably an oval compression sleeve 7 is used to splice rope 2 into a loop for engagement with spring snap 5.

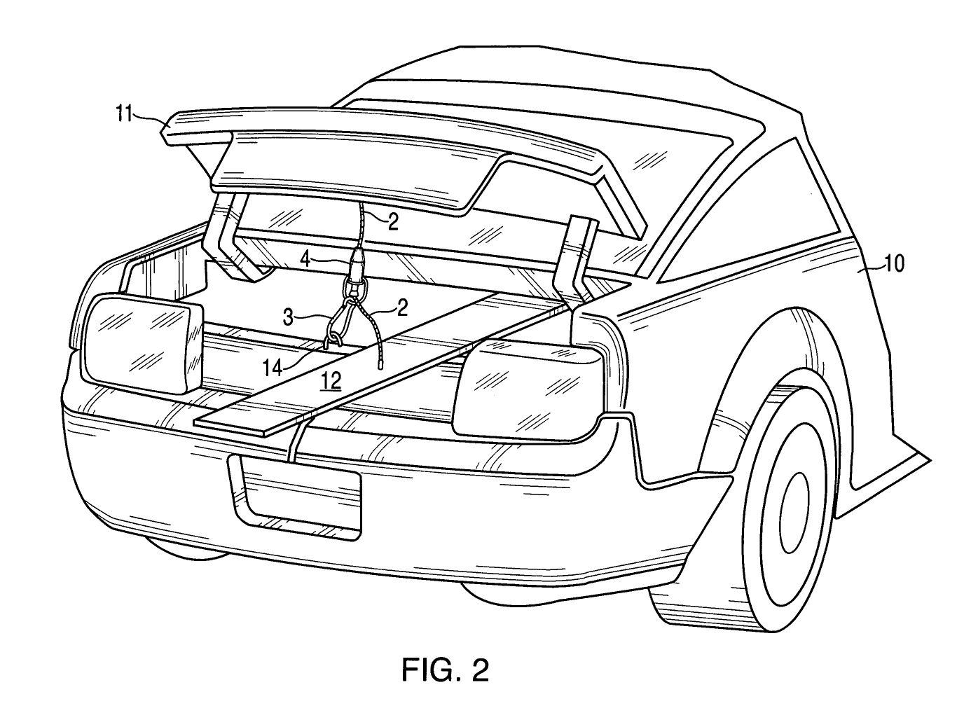

FIG. 2 illustrates a typical use of assembly 1 although only a portion is visible. The rear end of vehicle 10 with open trunk is shown with a protruding cargo object, such as a long plank 12, protruding from the trunk with the trunk lid 11 still open (in an up position). Spring snap 3 is shown snapped onto the trunk lock loop 14 while the upper end of non-stretch rope 2 (not shown) in engaged with a structural frame member on the inside of trunk lid 11. The lower end of non-stretch rope 2 is threaded through the ball line tightener 4. In use, an end of non-stretch rope 2 is pulled further through ball line tightener 4 to cause the trunk lid 11 to be pulled down in contact with the protruding cargo object, such as plank 12.

FIG. 3 shows a loop 17 of auxiliary non-stretch rope around the trunk lid 16 to form an internal attachment point for spring snap 5, when the inside of trunk lid 11 is covered by a fabric or other cover. In that case loop 17 wraps around trunk lid 16 and one of the spring snaps 3 or 5 engages a portion of the loop 17 adjacent to an inside of the trunk lid 16.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

We claim:

1. An adjustable length vehicle trunk lock which prevents violent excursions of a tied-down trunk lid of an open vehicle trunk carrying a protruding cargo object preventing complete closing of the trunk lid during travel, comprising in combination:
a vehicle trunk having a trunk lock structural loop and a hinged trunk lid;
a locking assembly including a non-stretch rope;
said locking assembly having a spring snap fitted at one proximal end of said non-stretch rope and a distal end of said non-stretch rope being fed through a ball line tightener;
said locking assembly having a second spring snap attached to said ball line tightener;
one of said spring snaps engageable with said trunk lock structural loop and another of said spring snaps engageable with said hinged lid;
wherein said non-stretch rope is then fed through said ball line tightener to facilitate snapping said spring snaps to said structural loop and said hinged trunk lid;
said non-stretch rope being tightened by pulling said hinged lid in contact with said protruding cargo object;
wherein said non-stretch rope used in its adjustable position prevents violent excursions of said hinged lid during a vehicle road trip to a destination.

2. The adjustable length vehicle trunk lock as in claim 1 wherein if the trunk or hatch lid interior is upholstered or otherwise devoid of attachment points, an auxiliary rope loop positioned around said hinged lid, located near a free end of said hinged lid and away from a hinge of said hinged lid provides an attachment point for one of said spring snaps.

3. The adjustable length vehicle trunk lock as in claim 1 wherein said non-stretch rope is polypropylene.

4. The adjustable length vehicle trunk lock as in claim 1 further comprising a soft bolster being provided between said hinged lid and its respective contact point with the protruding cargo object.

5. The adjustable length vehicle trunk lock as in claim 1 further comprising:
an oval compression sleeve splicing said non-stretch rope into a loop for engagement with one of said spring snaps.

6. The adjustable length vehicle trunk lock as in claim 1 wherein one of said spring snaps is attached to said ball line tightener by a ring extending from said ball line tightener.

7. The adjustable length vehicle trunk lock as in claim 1 wherein respective ends of said non-stretch rope are sealed against fraying by a sealer.

8. A method of tying down a hinged vehicle trunk lid prevented from closing by a protruding cargo object comprising the steps of:
providing a tie-down assembly with a spring snap fitted at one end of a non-stretch rope and threading another end of said non stretch rope through a ball line tightener;
engaging a spring snap of a pair of spring snaps with said ball line tightener;
splicing said non-stretch rope into a loop and engaging one of said spring snaps;
snapping one of said spring snaps onto a trunk lock loop of a vehicle having the hinged lid; engaging another spring snap to a structural frame member on an inside of said trunk lid;
threading a lower end of said non-stretch rope through a ball line tightener; and,
pulling said non-stretch rope further through said ball line tightener to cause said trunk lid to be pulled down in contact with the protruding cargo object.
